(19) United States
(12) Patent Application Publication
(10) Pub. No.: US 2019/0326624 A1
(43) Pub. Date: Oct. 24, 2019

(54) NONAQUEOUS ELECTROLYTE LIQUID IN WHICH ORGANIC MOLECULE IS COORDINATED TO ALKALINE EARTH METAL CATION, AND ALKALINE EARTH METAL SECONDARY BATTERY USING THE SAME

(71) Applicant: Panasonic Intellectual Property Management Co., Ltd., Osaka (JP)

(72) Inventors: TOMOFUMI HAMAMURA, Osaka (JP); KENSUKE NAKURA, Osaka (JP); TOSHIRO KUME, Hyogo (JP)

(21) Appl. No.: 16/364,101

(22) Filed: Mar. 25, 2019

(30) Foreign Application Priority Data
Apr. 23, 2018 (JP) 2018-082263

(51) Int. Cl. H01M 10/056; H01M 10/054

(52) U.S. Cl. CPC H01M 10/056; H01M 10/26; H01M 2300/0028; H01M 10/054

(57) ABSTRACT

A nonaqueous electrolyte liquid for an alkaline earth metal secondary battery includes: a nonaqueous solvent: an alkaline earth metal cation; an organic molecule coordinated to the alkaline earth metal cation; and an anion. The organic molecule is a carbonic acid ester, a carboxylic acid ester, a phosphoric acid ester, or a sulfonic acid ester.

### BACKGROUND

### 1. Technical Field

The present disclosure relates to a nonaqueous electrolyte liquid for an alkaline earth metal secondary battery and an alkaline earth metal secondary battery using the same.

### 2. Description of the Related Art

In recent years, development of an alkaline earth metal secondary battery has been desired.

Japanese Unexamined Patent Application Publication No. 2017-145197 has disclosed an electrolyte liquid containing Mg(CH₃CN)₆(PF₆)₂.

### SUMMARY

In one general aspect, the techniques disclosed here feature a nonaqueous electrolyte liquid for an alkaline earth metal secondary battery, the nonaqueous electrolyte liquid comprising: a nonaqueous solvent, an alkaline earth metal cation, an organic molecule coordinated to the alkaline earth metal cation, and an anion. The organic molecule is a carbonic acid ester, a carboxylic acid ester, a phosphoric acid ester, or a sulfonic acid ester.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view schematically showing a structural example of an alkaline earth metal secondary battery;

FIG. 2 shows ²⁵Mg-NMR spectra of Samples 1 and 2;

FIG. 3 shows Fourier Transformer Infrared (FTIR) spectra of Samples 1 and 3; and

FIG. 4 shows voltammograms of Samples 1 and 2.

### DETAILED DESCRIPTION

Hereinafter, a nonaqueous electrolyte liquid according to an embodiment and an alkaline earth metal secondary battery using the same will be described in detail with reference to the drawings.

The following descriptions each indicate a comprehensive or a concrete example. The following numeral values, compositions, shapes, film thicknesses, electric characteristics, secondary battery structures, and the like are described by way of example and are not intended to limit the present disclosure. In addition, a constituent element not described in an independent claim which indicates the topmost concept is an arbitrary constituent element.

### [1. Nonaqueous Electrolyte Liquid]

Since being capable of using a two-electron reaction of an alkaline earth metal, an alkaline earth metal secondary battery is expected to be practically used as a high capacity secondary battery. However, since a divalent alkaline earth metal cation has a strong coulomb interaction with at least one anion present therearound, the solubility of the alkaline earth metal salt in a nonaqueous solvent is typically low. This is a specific problem of a nonaqueous electrolyte liquid for an alkaline earth metal secondary battery. For example, in a current lithium ion battery, although a nonaqueous electrolyte liquid in which LiPF₆ is dissolved in ethylene carbonate is used, Mg(PF₆)₂ is not dissolved in an aprotic solvent. According to the problem described above, in the alkaline earth metal secondary battery, the combination between a nonaqueous solvent and an alkaline earth metal salt is strictly restricted.

In consideration of the above situation, the present inventors discovered the following novel nonaqueous electrolyte liquid.

A nonaqueous electrolyte liquid for an alkaline earth metal secondary battery according to this embodiment comprises a nonaqueous solvent, an alkaline earth metal cation, an organic molecule coordinated to the alkaline earth metal cation, and an anion. The organic molecule is a carbonic acid ester, a carboxylic acid ester, a phosphoric acid ester, or a sulfonic acid ester.

For example, a nonaqueous electrolyte liquid may be formed by dissolving an alkaline earth metal salt which contains an alkaline earth metal cation, an organic molecule functioning as a ligand, and an anion in a nonaqueous solvent. Alternatively, a nonaqueous electrolyte liquid may also be formed in such a way that after another alkaline earth metal salt is dissolved in a nonaqueous solvent, ligand exchange is performed. Hereinafter, for the convenience of illustration, of the nonaqueous electrolyte liquid, a component formed of an alkaline earth metal cation, an organic molecule, and an anion is collectively called an “alkaline earth metal salt” in some cases; however, it is not intended to limit a manufacturing method thereof.

According to the nonaqueous electrolyte liquid of this embodiment, since the organic molecule is coordinately bonded to the alkaline earth metal cation, the solubility of the alkaline earth metal salt in the nonaqueous solvent is increased, and hence, the degree of selection of the nonaqueous solvent is increased. Hence, in accordance with desired conditions, an appropriate nonaqueous solvent can be selected. The “desired conditions” may include, for example, at least one of a high alkaline earth metal ion conductivity, an electrochemical stability, a chemical stability, a thermal stability, safety, a low environmental load, and inexpensiveness. For example, when the alkaline earth metal salt is dissolved in a nonaqueous solvent at a high concentration, the alkaline earth metal ion conductivity of the nonaqueous electrolyte liquid can be increased. For example, when a nonaqueous solvent having a high oxidation resistance is selected, a nonaqueous electrolyte liquid having an electrochemical stability can be obtained. For example, when a nonaqueous solvent having a low toxicity is selected, a nonaqueous electrolyte liquid having a high safety can be obtained.

As an example of the alkaline earth metal cation, Mg²⁺, Ca²⁺, Sr²⁺, and Ba²⁺ may be mentioned. The alkaline earth metal cation is, for example, Mg²⁺.

An organic molecule having an ester group tends to have a high reduction resistance and, for example, has a high reduction resistance as compared to that of acetonitrile. Hence, the organic molecule as described above can suppress a reduction decomposition reaction of the electrolyte liquid and can improve withstand voltage characteristics of the electrolyte liquid.

As the carbonic acid ester, there may be used either a cyclic carbonic acid ester or a chain carbonic acid ester. As an example of the cyclic carbonic acid ester, ethylene carbonate, propylene carbonate, butylene carbonate, vinylene carbonate, fluoroethylene carbonate, 4,5-difluoroethylene carbonate, 4,4,4-trifluoroethylene carbonate, fluoromethyl ethylene carbonate, trifluoromethyl ethylene carbonate, 4-fluoropropylene carbonate, 5-fluoropropylene carbonate, and derivatives thereof may be mentioned. As an example of the chain carbonic acid ester, dimethyl carbonate, ethyl methyl carbonate, diethyl carbonate, methyl propyl carbonate, ethyl propyl carbonate, methyl isopropyl carbonate, and derivatives thereof may be mentioned.

As the carboxylic acid ester, there may be used either a cyclic carboxylic acid ester or a chain carboxylic acid ester. As an example of the cyclic carboxylic acid ester, γ-butyrolactone, γ-valerolactone, γ-caprolactone, ε-caprolactone, α-acetolactone, and derivatives thereof may be mentioned. As an example of the chain carboxylic acid ester, methyl acetate, ethyl acetate, propyl acetate, butyl acetate, methyl propionate, ethyl propionate, propyl propionate, butyl propionate, and derivatives thereof may be mentioned.

As an example of the phosphoric acid ester, trimethyl phosphate, triethyl phosphate, tributyl phosphate, trifluoroethyl phosphate, triphenyl phosphate, tritolyl phosphate, and derivatives thereof may be mentioned.

As an example of the sulfonic acid ester, methyl methane sulfonate, ethyl methane sulfonate, methyl ethane sulfonate, propyl methane sulfonate, 2-methoxyethyl methane sulfonate, 2,2,2-trifluoroethyl methane sulfonate, phenyl methane sulfonate, methyl benzene sulfonate, and derivatives thereof may be mentioned.

In view of a high dielectric constant, the cyclic carbonic acid ester may be selected. Accordingly, the solubility of the alkaline earth metal salt can be increased. As the cyclic carbonic acid ester, for example, ethylene carbonate or propylene carbonate may be used.

The alkaline earth metal salt contains an anion, and the anion is, for example, a monovalent anion.

As an example of the anion, there may be mentioned Cl⁻, Br⁻, I⁻, BF₄⁻, PF₆⁻, AsF₆⁻, SbF₆⁻, SiF₆⁻, ClO₄⁻, AlCl₄⁻, FSO₃⁻, CF₃SO₃⁻, C₄F₉SO₃⁻, [N(FSO₂)₂]⁻, [N(CF₃SO₂)₂]⁻, [N(C₂F₅SO₂)₂]⁻, [N(FSO₂)(CF₃SO₂)]⁻, CF₃BF₃⁻, C₂F₅BF₃⁻, CB₁₁H₁₂⁻, and derivatives thereof.

In view of the electrochemical stability, BF₄⁻, PF₆⁻, ClO₄⁻, AlCl₄⁻, [N(CF₃SO₂)₂]⁻, [N(C₂F₅SO₂)₂]⁻, or CB₁₁H₁₂⁻ may be selected. In view of the solubility, PF₆⁻, FSO₃⁻, [N(CF₃SO₂)₂]⁻, [N(C₂F₅SO₂)₂]⁻, or CB₁₁H₁₂⁻ may be selected.

In the alkaline earth metal salt, for example, n ligands (where n is an integer of 1 to 6) may be coordinated to the alkaline earth metal cation. The n ligands are each a neutral organic molecule, and at least one of the ligands has a double bonded oxygen atom. Some of the n ligands each may have a double bonded oxygen atom, or all the ligands each may have a double bonded oxygen atom. For example, n may also be from 4 to 6. In this case, the “double bonded oxygen atom” indicates an oxygen atom having a double bond with an atom other than oxygen. This oxygen atom may have a double bond with a carbon atom, a phosphorus atom, a sulfur atom, or the like.

The alkaline earth metal salt may have, for example, an octahedral coordination structure in which six ligands are coordinated to the alkaline earth metal cation. The six ligands are each a neutral organic molecule or the like, and at least one of the ligands has a double bonded oxygen atom. Some of the six ligands each may have a double bonded oxygen atom, or all the ligands each may have a double bonded oxygen atom.

The alkaline earth metal salt is represented, for example, by a general formula of MLₙA₂ (in the formula, M represents an alkaline earth metal, Ln represents n ligands, A represents an anion, and n indicates an integer of 1 to 6). At least one of the n ligands is an organic molecule having a double bonded oxygen atom.

As the nonaqueous solvent, any liquid capable of dissolving the alkaline earth metal salt may be used, and for example, the liquid may contain the ester mentioned above. The nonaqueous solvent may contain an organic molecule which is the same type of the organic molecule coordinated to the alkaline earth metal.

The nonaqueous solvent may contain another solvent. As an example of the another solvent, a cyclic ether, a chain ether, a boric acid ester, a cyclic sulfone, a chain sulfone, a nitrile, and a sultone may be mentioned.

### [2. Method for Manufacturing Nonaqueous Electrolyte Liquid]

A method for manufacturing the nonaqueous electrolyte liquid according to this embodiment comprises, for example, a step of synthesizing a first complex salt as a precursor in which acetonitrile is coordinated to an alkaline earth metal cation and a step of dissolving the first complex salt in a solvent to produce a second complex salt in which at least one organic molecule contained in the solvent is coordinated to the alkaline earth metal cation. After the second complex salt is produced, this manufacturing method may further comprise a step of adding another nonaqueous solvent. Alternatively, after the second complex salt is produced, this manufacturing method may further comprise a step of drying a solution containing the second complex salt to obtain the second complex salt in the form of solid.

First, iodine is added to an alkaline earth metal in dried acetonitrile to activate the alkaline earth metal. In an inert atmosphere at room temperature, a solution in which a nitrosonium salt is dissolved in dried acetonitrile is prepared. As an example of the nitrosonium salt, NOPF₆, NOClO₄, and NOBF₄ may be mentioned. The activated alkaline earth metal is charged in the above solution and is the stirred. Subsequently, the solution is heated to remove the solvent, so that M(CH₃CN)ₙA₂ is obtained as the precursor. In addition, in order to increase the purity of the precursor, re-crystallization may be repeatedly performed.

Next, the precursor is charged into an organic solvent containing a desired organic molecule and is then stirred at room temperature for 1 to 10 hours. Accordingly, the precursor is dissolved in the organic solvent, and the acetonitrile coordinated to the alkaline earth metal cation is replaced with the desired organic molecule. As a result, a solution containing the nonaqueous solvent and MLₙA₂, which is the complex salt, is obtained. This solution may be used as the nonaqueous electrolyte liquid without any further modification. In addition, the coordination number n may be determined by the type of alkaline earth metal, the type of organic molecule functioning as the ligand, and the combination therebetween.

Furthermore, the solvent may be removed from this solution at a vacuum reduced pressure so as to precipitate the alkaline earth metal salt MLₙA₂. The alkaline earth metal salt thus precipitated may be dissolved in another nonaqueous solvent so as to form a nonaqueous electrolyte liquid.

In this case, as the organic molecule L, any organic molecule capable of performing ligand exchange with acetonitrile may be used. As the organic molecule L, for example, a molecule having a relatively small steric hindrance may be used, or a molecule having a larger donor number (such as DN>14) than that of acetonitrile may also be used. In addition, some of the n acetonitrile molecules may be ligand-exchanged, or all the acetonitrile molecules may be ligand-exchanged.

When the raw material is appropriately changed, this manufacturing method may also be used for synthesis of another alkaline earth metal complex salt. For example, in the above manufacturing method, when NOPF₆ is changed to NOBF₄, MgLₙ(BF₄)₂ can be synthesized.

In the present disclosure, the alkaline earth metal salt containing the organic molecule L as the ligand may be obtained in advance before dissolution in the solvent or may be obtained as a result after dissolution in the solvent.

The composition of the nonaqueous electrolyte liquid thus obtained may be determined, for example, by an inductively-coupled plasma (ICP) emission spectral analysis method. The crystalline structure of the alkaline earth metal salt can be determined by a powder X-ray analysis performed on a re-crystallized alkaline earth metal salt which is obtained from the nonaqueous electrolyte liquid by re-crystallization.

### [3. Alkaline Earth Metal Secondary Battery]

### [3-1. Entire Structure]

The nonaqueous electrolyte liquid according to this embodiment can be used for an alkaline earth metal secondary battery. That is, the alkaline earth metal secondary battery comprises a positive electrode, a negative electrode, and a nonaqueous electrolyte liquid having an alkaline earth metal ion conductivity. As the nonaqueous electrolyte liquid, the liquid described in the above [1. Nonaqueous Electrolyte Liquid] may be appropriately used.

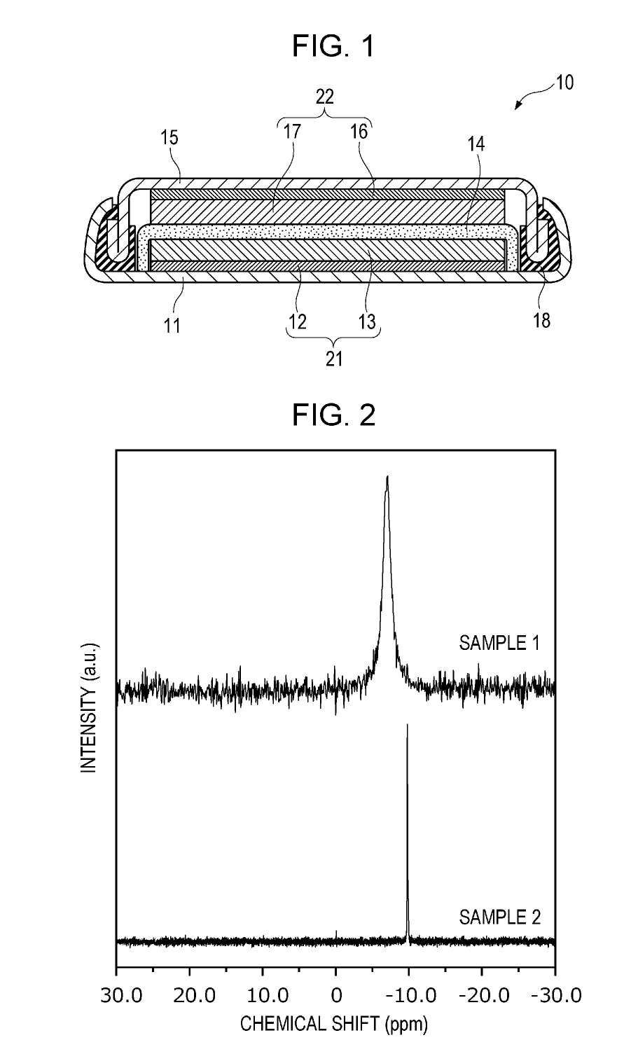

FIG. 1 is a cross-sectional view schematically showing a structural example of an alkaline earth metal secondary battery 10.

The alkaline earth metal secondary battery 10 comprises a positive electrode 21, a negative electrode 22, a separator 14, a case 11, a sealing plate 15, and a gasket 18. The separator 14 is disposed between the positive electrode 21 and the negative electrode 22. In the positive electrode 21, the negative electrode 22, and the separator 14, a nonaqueous electrolyte liquid is impregnated, and those components mentioned above are received in the case 11. The case 11 is sealed by the gasket 18 and the sealing plate 15.

The structure of the alkaline earth metal secondary battery 10 may be, for example, a cylindrical type, a square type, a button type, a coin type, or a flat type.

### [3-2. Positive Electrode]

The positive electrode 21 includes a positive electrode collector 12 and a positive electrode active material layer 13 disposed on the positive electrode collector 12.

The positive electrode active material layer 13 contains a positive electrode active material. The positive electrode active material may be, for example, fluorinated graphite, a metal oxide, or a metal halide. The metal oxide and the metal halide each may contain, for example, an alkaline earth metal and at least one selected from scandium, titanium, vanadium, chromium, manganese, iron, cobalt, nickel, copper, and zinc. The positive electrode active material may also be either a sulfide such as Mo₆S₈ or a chalcogenide compound such as Mo₉Se₁₁.

In the case in which the alkaline earth metal secondary battery 10 is a magnesium secondary battery, as an example of the positive electrode active material, there may be mentioned MgM₂O₄ (M represents at least one selected from Mn, Co, Cr, Ni, and Fe), MgMO₂ (M represents at least one selected from Mn, Co, Cr, Ni, and Al), MgMSiO₄ (M represents at least one selected from Mn, Co, Ni, and Fe), and MgₓM_{y}AO_{z}F_{w} (M represents a transition metal such as Sn, Sb, or In; A represents P, Si, or S; and 0<x≤2, 0.5≤y≤1.5, z=3 or 4, and 0.5≤w≤1.5 are satisfied).

In the case in which the alkaline earth metal secondary battery 10 is a calcium secondary battery, as an example of the positive electrode active material, CaM₂O₄ and CaMO₂ (M represents at least one selected from Mn, Co, Ni, and Al) may be mentioned.

The positive electrode active material layer 13 may further contain, if needed, an electrically conductive agent and/or a binding agent.

As an example of the electrically conductive agent, there may be mentioned a carbon material, a metal, an inorganic compound, and an electrically conductive high molecular weight material. As an example of the carbon material, there may be mentioned graphite such as natural graphite (massive graphite, flake graphite, or the like) or artificial graphite, acetylene black, carbon black, Ketjen black, carbon whiskers, needle coke, and carbon fibers. As an example of the metal, there may be mentioned copper, nickel, aluminum, silver, and gold. As an example of the inorganic compound, there may be mentioned tungsten carbide, titanium carbide, tantalum carbide, molybdenum carbide, titanium boride, and titanium nitride. Those materials may be used alone, or at least two types thereof may be used in combination.

As an example of the binding agent, there may be mentioned a fluorine-containing resin, such as a polytetrafluoroethylene (PTFE), a polyvinylidene fluoride (PVdF), or a fluororubber; a thermoplastic, such as a polypropylene or a polyethylene; an ethylene propylene diene monomer (EPDM) rubber, a sulfonated EPDM rubber, and a natural butyl rubber (NBR). Those materials may be used alone, or at least two types thereof may be used in combination.

As an example of a solvent dispersing the positive electrode active material, the electrically conductive agent, and the binding agent, there may be mentioned N-methylpyrrolidone, dimethylformamide, dimethylacetamide, methyl ethyl ketone, cyclohexanone, methyl acetate, methyl acrylate, diethylenetriamine, N,N-dimethylaminopropylamine, ethylene oxide, and tetrahydrofuran. For example, a thickening agent may also be added to the dispersant. As an example of the thickening agent, there may be mentioned a carboxymethyl cellulose and a methyl cellulose.

The positive electrode active material layer 13 is formed, for example, as described below. First, the positive electrode active material, the electrically conductive agent, and the binding agent are mixed together. Next, an appropriate solvent is added to the mixture thus formed, so that a positive electrode mixture agent in the form of past is obtained. Subsequently, this positive electrode mixture agent is applied on a surface of the positive electrode collector 12 and is then dried. Accordingly, the positive electrode active material layer 13 is formed on the positive electrode collector 12. In addition, in order to increase the electrode density, the positive electrode active material layer 13 may be compressed.

The film thickness of the positive electrode active material layer 13 is not particularly limited and may be, for example, 1 to 100 μm.

A material of the positive electrode collector 12 is, for example, a metal or an alloy. In more particular, the material of the positive electrode collector 12 may be at least one metal selected from the group consisting of copper, chromium, nickel, titanium, platinum, gold, aluminum, tungsten, iron, and molybdenum or an alloy thereof. The material of the positive electrode collector 12 may be, for example, stainless steel.

The positive electrode collector 12 may have a plate shape of a foil shape. The positive electrode collector 12 may also be a laminated film.

When the case 11 also functions as the positive electrode collector, the positive electrode collector 12 may be omitted.

### [3-3. Negative Electrode]

The negative electrode 22 includes, for example, a negative electrode active material layer 17 containing a negative electrode active material and a negative electrode collector 16.

The negative electrode active material layer 17 contains a negative electrode active material capable of occluding and releasing alkaline earth metal ions. In this case, as an example of the negative electrode active material, a carbon material may be mentioned. As an example of the carbon material, graphite, non-graphitized carbon, such as hard carbon or coke, and a graphite intercalation compound may be mentioned.

The negative electrode active material layer 17 may further contain, if needed, an electrically conductive agent and/or a binding agent. As the electrically conductive agent, the binding agent, a solvent, and a thickening agent, for example, the materials described in [3-2. Positive Electrode] may be appropriately used.

The film thickness of the negative electrode active material layer 17 is not particularly limited and is, for example, 1 to 50 μm.

Alternatively, the negative electrode active material layer 17 contains a negative electrode active material capable of dissolving and precipitating an alkaline earth metal. In this case, as an example of the negative electrode active material, there may be mentioned an Mg metal and an Mg alloy. The Mg alloy is, for example, an alloy of an alkaline earth metal and at least one selected from aluminum, silicon, gallium, zinc, tin, manganese, bismuth, and antimony.

As a material of the negative electrode collector 16, for example, a material similar to that of the positive electrode collector 12 described in the above [3-2. Positive Electrode] may be appropriately used. The negative electrode collector 16 may have either a plate shape or a foil shape.

When the case 11 also functions as the negative electrode collector, the negative electrode collector 16 may be omitted.

In the case in which the negative electrode collector 16 is formed of a material capable of dissolving and precipitating an alkaline earth metal on the surface thereof, the negative electrode active material layer 17 may be omitted. That is, the negative electrode 22 may be formed only from the negative electrode collector 16 capable of dissolving and precipitating an alkaline earth metal. In this case, the negative electrode collector 16 may be formed of stainless steel, nickel, copper, or iron.

### [3-4. Separator]

As an example of a material of the separator 14, a fine porous thin film, a woven cloth, and a non-woven cloth may be mentioned. As the material of the separator 14, a polyolefin, such as a polypropylene or a polyethylene, may also be used. The film thickness of the separator 14 is, for example, 10 to 300 μm. The separator 14 may be either a single layer film formed from one type of material or a composite film (or a multilayer film) formed of at least two types of materials. The porosity of the separator 14 is, for example, in a range of 30% to 70%.

### [4. Experimental Results]

### [4-1. Formation of Nonaqueous Electrolyte Liquid]

### [4-1-1. Sample 1]

First, a small amount of iodine was added to an Mg metal in dried acetonitrile to activate the Mg metal. In a solution in which NOPF₆ was dissolved in dried acetonitrile, the Mg metal thus activated was charged and was then stirred. Subsequently, the solution was heated, so that Mg(CH₃CN)₆(PF₆)₂ was obtained as a precursor.

Next, as a nonaqueous solvent, propylene carbonate was prepared, and the precursor was dissolved therein to have a concentration of 0.12 mol/L. Accordingly, Sample 1 of the nonaqueous electrolyte liquid was obtained.

### [4-1-2. Sample 2]

Mg(CH₃CN)₆(PF₆)₂ formed by a method similar to that of Sample 1 was dissolved in a mixed solvent of acetonitrile and tetrahydrofuran (volume ratio 1:1) to have a concentration of 0.12 mol/L. Accordingly, Sample 2 of the nonaqueous electrolyte liquid was obtained.

### [4-1-3. Sample 3]

Except for that the concentration was set to 1.2 mol/L, Sample 3 of the nonaqueous electrolyte liquid was formed by a method similar to that of Sample 1.

### [4-1-4. Others]

Mg(PF₆)₂ (manufactured by American Elements) was prepared and was then charged in propylene carbonate. However, Mg(PF₆)₂ was not dissolved in propylene carbonate. When the result thus obtained was compared to Sample 1, it is believed that since being a complex salt, the magnesium salt contained in Sample 1 has solubility in propylene carbonate.

### [4-1-5. Complement]

Samples 1 and 3 correspond to Examples of the nonaqueous electrolyte liquid according to this embodiment, and Sample 2 corresponds to Comparative Example. In addition, the magnesium salt contained in Sample 2 corresponds to the precursor of Sample 1.

### [4-2. ²⁵Mg-NMR Measurement]

²⁵Mg-nuclear magnetic resonance (NMR) measurement was performed on Sample 1 and Sample 2. For this measurement, a nuclear magnetic resonance apparatus (manufactured by JEOL Ltd., JNM-ECA600) was used. The temperature condition was set to 25° C.

FIG. 2 shows ²⁵Mg-NMR spectra of Sample 1 and Sample 2. In FIG. 2, the horizontal axis represents the chemical shift, and the vertical axis represents a normalized signal intensity.

The ²⁵Mg-NMR spectra of Sample 1 and Sample 2 had peaks at approximately −7.10 ppm and −9.75 ppm, respectively. The chemical shift of Sample 1 was different from the chemical shift of Sample 2. This indicates that during the formation of Sample 1, acetonitrile contained in the precursor was ligand-exchanged by propylene carbonate. That is, it is estimated that Sample 1 is a nonaqueous electrolyte liquid including a nonaqueous solvent which contains propylene carbonate and a small amount of acetonitrile and Mg(PC)₆(PF₆)₂ (in this formula, PC represents propylene carbonate: C₄H₆O₃). In addition, from the result described above, it is estimated that the magnesium salt contained in Sample 3 is also Mg(PC)₆(PF₆)₂.

### [4-3. FTIR Measurement]

Fourier transform infrared spectroscopy (FTIR) measurement was performed on Sample 1 and Sample 3. For this measurement, an infrared spectroscopy apparatus (manufactured by Thermo Scientific, Nicolet iS50) was used. The temperature condition was set to 25° C.

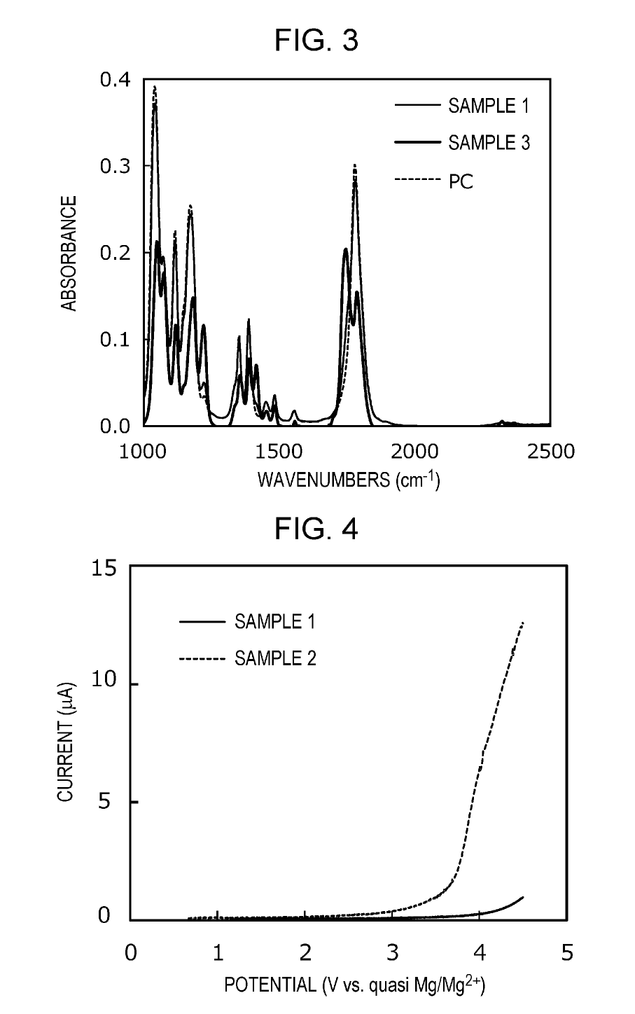

FIG. 3 shows IR spectra of Sample 1 and Sample 3 together with an IR spectrum of propylene carbonate. In FIG. 3, the horizontal axis represents the wavenumber, and the vertical axis represents the absorbance.

As shown in FIG. 3, the spectra each showed a peak derived from the stretching vibration mode of a carbonyl group (C═O) approximately at a wavenumber of 1,700 to 1,800 cm⁻¹. Hereinafter, those peaks are compared to each other.

Although Sample 1 shows a single peak at the same wavenumber as that of the peak of propylene carbonate, the peak value of Sample 1 is slightly lower than that of propylene carbonate, and in addition, the foot of the peak described above is extended to a low wavenumber side. Sample 3 shows two peaks at the same wavenumber as that of the peak of propylene carbonate and at a slightly lower wavenumber than that thereof. That is, the peaks of Sample 1 and Sample 3 each have a peak component at a slightly lower wavenumber than that of propylene carbonate, and the intensity of this peak component relates to the concentration of the magnesium salt. From this result, this peak component is believed to be derived from the C═O stretching of propylene carbonate coordinated to the magnesium cation.

### [4-4. Evaluation of Ion Conductivity]

The ion conductivity of Sample 1 was measured using an electrical conduction meter (manufactured by DKK-Towa Corporation, CM-30R). The temperature condition was set to 25° C. As a result, the ion conductivity of Sample 1 was 3.9 mS/cm.

### [4-5. Evaluation of LSV Characteristics]

Linear sweeping voltammetry (LSV) measurement was performed on Sample 1 and Sample 2. As a measurement cell, an H type cell was used, and as a measurement device, a potentio galvanostat (manufactured by Solartron Analytical, Celltest System 1470E) was used. As a working electrode, aluminum foil having a size of 5 mm by 40 mm was used, and as a reference electrode and a counter electrode, a magnesium ribbon having a size of 5 mm by 40 mm was used. A sweep rate of the potential was set to 5 mV/s, and a sweep range thereof is set to 1.0 to 4.5 V.

FIG. 4 shows voltammograms obtained by the LSV measurement of Sample 1 and Sample 2. The vertical axis represents a current flowing through the working electrode, and the horizontal axis represents the potential of the working electrode with respect to that of the reference electrode. A potential of Sample 1 at which an oxidation current rose up was high as compared to that of Sample 2. That is, the oxidation resistance of Sample 1 was superior to that of Sample 2. The reason for this is believed that propylene carbonate contained in Sample 1 has a high oxidation resistance as compared to that of tetrahydrofuran contained in Sample 2.

What is claimed is:

1. A nonaqueous electrolyte liquid for an alkaline earth metal secondary battery, the nonaqueous electrolyte liquid comprising:
a nonaqueous solvent:
an alkaline earth metal cation;
an organic molecule coordinated to the alkaline earth metal cation; and
an anion,
wherein the organic molecule is a carbonic acid ester, a carboxylic acid ester, a phosphoric acid ester, or a sulfonic acid ester.

2. The nonaqueous electrolyte liquid according to claim 1,
wherein the alkaline earth metal cation is a magnesium cation.

3. The nonaqueous electrolyte liquid according to claim 1,
wherein the organic molecule is a carbonic acid ester.

4. The nonaqueous electrolyte liquid according to claim 1,
wherein the organic molecule is propylene carbonate.

5. The nonaqueous electrolyte liquid according to claim 1,
wherein the alkaline earth metal cation is coordinated by n ligands, where n indicates an integer of 1 to 6, and
at least one of the n ligands is the organic molecule.

6. The nonaqueous electrolyte liquid according to claim 5,
wherein all the n ligands are same as the organic molecule.

7. The nonaqueous electrolyte liquid according to claim 1,
wherein the anion is at least one selected from the group consisting of Cl⁻, Br⁻, I⁻, BF₄⁻, PF₆⁻, AsF₆⁻, SbF₆⁻, SiF₆⁻, ClO₄⁻, AlCl₄⁻, FSO₃⁻, CF₃SO₃⁻, C₄F₉SO₃⁻, [N(FSO₂)₂]⁻, [N(CF₃SO₂)₂]⁻, [N(C₂F₅SO₂)₂]⁻, [N(FSO₂)(CF₃SO₂)₂]⁻, CF₃BF₃⁻, C₂F₅BF₃⁻, and CB₁₁H₁₂⁻.

8. The nonaqueous electrolyte liquid according to claim 7,
wherein the anion is at least one selected from the group consisting of PF₆⁻, FSO₃⁻, [N(FSO₂)₂]⁻, [N(CF₃SO₂)₂]⁻, [N(C₂F₅SO₂)₂]⁻, and CB₁₁H₁₂⁻.

9. The nonaqueous electrolyte liquid according to claim 1,
wherein the nonaqueous solvent contains an organic molecule which is the same as the organic molecule.

10. An alkaline earth metal secondary battery comprising:
a positive electrode;
a negative electrode: and
the nonaqueous electrolyte liquid according to claim 1.
